(19) United States
(12) Patent Application Publication
(10) Pub. No.: US 2013/0194694 A1
(43) Pub. Date: Aug. 1, 2013

(54) SPINDLE MOTOR

(71) Applicant: Sang Jin PARK, Suwon (KR)

(72) Inventor: Sang Jin PARK, Suwon (KR)

(73) Assignee: SAMSUNG ELECTRO-MECHANICS CO., LTD, Suwon (KR)

(21) Appl. No.: 13/449,553

(22) Filed: Apr. 18, 2012

(30) Foreign Application Priority Data
Jan. 27, 2012 (KR) 10-2012-0008061

(51) Int. Cl. H02K 7/08; G11B 19/20; G11B 21/02

(52) U.S. Cl. 360/75; 310/90; G9B/19.027; G9B/21.003

(57) ABSTRACT

There is provided a spindle motor including: a sleeve provided with a shaft protruded in an upward axial direction and having oil filling a bearing clearance formed between the sleeve and the shaft, the sleeve rotatably supporting the shaft; a base member including a mounting part protruded in the upward axial direction, the mounting part having the sleeve fixed to an inner surface thereof; and a hub fixed to an upper portion of the shaft and including a main wall part, the main wall part being formed with at least a portion of an inner surface thereof corresponding to an outer surface of the sleeve and being formed with at least a portion of an outer surface thereof corresponding to the inner surface of the mounting part, the main wall part and the mounting part having an interval therebetween widening in the downward axial direction.

### CROSS-REFERENCE TO RELATED APPLICATIONS

This application claims the priority of Korean Patent Application No. 10-2012-0008061 filed on Jan. 27, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device, reads data stored on a disk or writes data to a disk by using a read/write head.

The hard disk drive requires a disk driving device capable of driving the disk. As the disk driving device, a small-sized motor is used.

As the small-sized motor, a hydrodynamic bearing assembly has been used. A rotating member and a fixed member of the hydrodynamic bearing assembly are spaced apart from each other by a predetermined interval to thereby form a bearing clearance interposed therebetween, and oil fills the bearing clearance, such that the rotating member is supported by fluid pressure generated in the oil.

Therefore, the bearing clearance between the rotating member and the fixed member, filled with the oil, is sealed while a liquid-vapor interface is formed at a predetermined position therein.

Here, since a position at which the liquid-vapor interface is formed is continuously changed, according to the operation or non-operation of the motor, the portion being a portion that may not be blocked by a separate cap, or the like. Therefore, the oil may be separated from the liquid-vapor interface due to an impact of the motor itself, an external impact, or the like, such that it may be scattered or leaked.

### RELATED ART DOCUMENT

Japanese Patent Laid-open Publication No. 2010-286071

### SUMMARY OF THE INVENTION

An aspect of the present invention provides a spindle motor capable of efficiently preventing fluid leakage through a simple structural configuration.

More specifically, an aspect of the present invention provides a spindle motor capable of preventing oil from being separated from a liquid-vapor interface through a structure allowing air to flow from an outer side of a portion in which the liquid-vapor interface is formed, that is, from an air side, toward the liquid-vapor interface.

According to an aspect of the present invention, there is provided a spindle motor including: a sleeve provided with a shaft protruded in an upward axial direction and having oil filling a bearing clearance formed between the sleeve and the shaft, the sleeve rotatably supporting the shaft; a base member including a mounting part protruded in the upward axial direction, the mounting part having the sleeve fixed to an inner surface thereof; and a hub fixed to an upper portion of the shaft and including a main wall part extended in a downward axial direction, the main wall part being formed with at least a portion of an inner surface thereof corresponding to an outer surface of the sleeve and being formed with at least a portion of an outer surface thereof corresponding to the inner surface of the mounting part, the main wall part and the mounting part having an interval therebetween widening in the downward axial direction.

The outer surface of the main wall part may be at least partially tapered so that an interval between the main wall part and the mounting part widens in the downward axial direction.

The outer surface of the main wall part may be formed to have at least one step so that an interval between the main wall part and the mounting part widens in the downward axial direction.

The interval between the main wall part and the mounting part may have a labyrinth seal formed therein at a narrowest point thereof.

The inner surface of the mounting part may be formed to have at least one step so as to be protruded in an inner diameter direction in the downward axial direction.

The outer surface of the main wall part may be stepped in the inner diameter direction so as to correspond to the step formed at the inner surface of the mounting part, and the mounting part and the main wall part may have respective corresponding surfaces on which the inner surface of the mounting part and the outer surface of the main wall part face each other, an interval between the respective corresponding surfaces distinguished from each other by the step widening in the downward axial direction.

The corresponding surfaces where a narrowest point in the interval between the outer surface of the main wall part and the inner surface of the mounting part is provided may have a labyrinth seal formed therebetween.

The outer surface of the sleeve and the inner surface of the main wall part may have a liquid-vapor interface formed therebetween.

According to another aspect of the present invention, there is provided a hard disk drive including: the spindle motor as described above rotating a disk with power applied through a board; a magnetic head writing data to the disk and reading the data from the disk; and a head driving part moving the magnetic head to a predetermined position on the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to another embodiment of the present invention;

FIG. 2 is a schematic cross-sectional view showing a spindle motor according to another embodiment of the present invention;

FIG. 3 is a schematic cross-sectional view showing a spindle motor according to another embodiment of the present invention; and

FIG. 4 is a schematic cross-sectional view of a disk driving device using the spindle motor according to the embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, when it is determined that a detailed description of the known art related to the present invention may obscure the gist of the present invention, a detailed description thereof will be omitted.

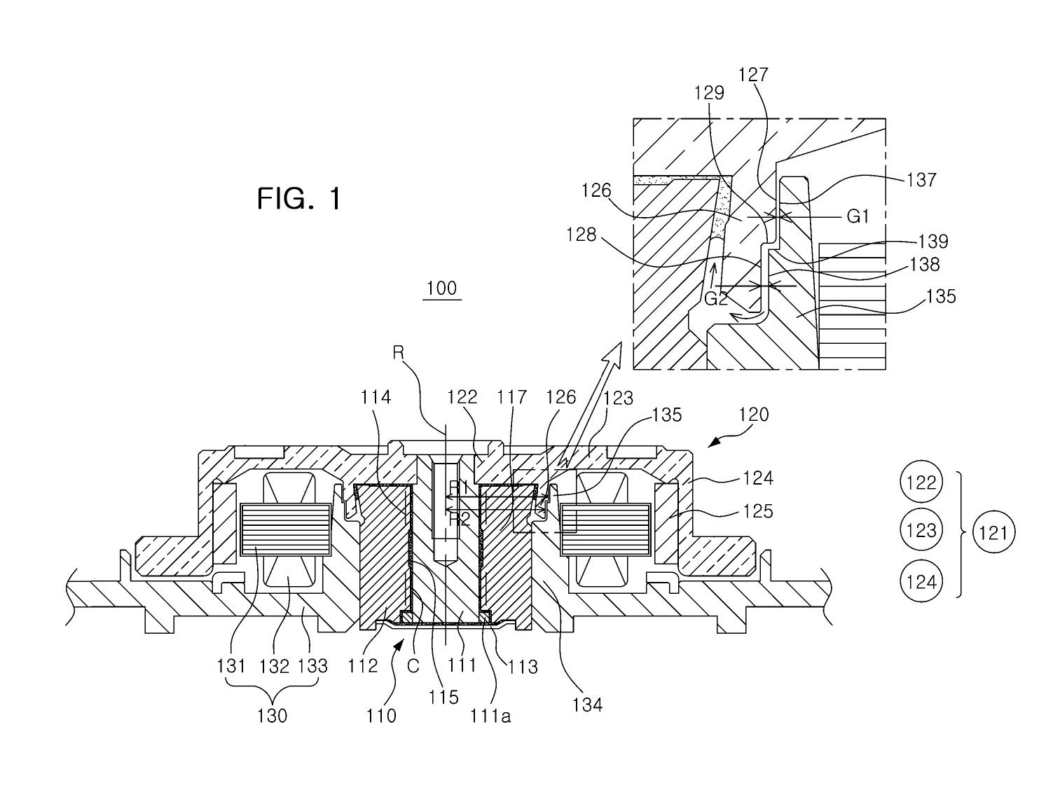

FIG. 1 is a schematic cross-sectional view showing a spindle motor according to another embodiment of the present invention.

Referring to FIG. 1, a motor 100, according to the embodiment of the present invention, may include a hydrodynamic bearing assembly 110 including a shaft 111 and a sleeve 112, a rotor 120 including a hub 121, and a stator 130 including a core 131 having a coil 132 wound therearound.

The hydrodynamic bearing assembly 110 may include the shaft 111, the sleeve 112, a stopper 111a, and the hub 121, wherein the hub 121 may be a component configuring the hydrodynamic bearing assembly 110 simultaneously with being a component configuring a rotor 120 to be described below.

Terms with respect to directions will first be defined. As viewed in FIG. 1, an axial direction refers to a vertical direction based on the shaft 111, and an outer diameter or inner diameter direction refers to a direction toward an outer edge of the hub 121 based on the shaft 111 or a direction toward the center of the shaft 111 based on the outer edge of the hub 121.

Further, in the following description, a rotating member may be a rotating member such as the shaft 111, the rotor 120 including the hub 121, the magnet 125 mounted on the rotor 120, and the like, and a fixed member, which is a member other than the rotating member, may be a member fixed, relative to the rotating member, such as the sleeve 112, the stator 130, a base member, and the like.

In addition, a communications path between an oil interface and the outside refers a path through which the oil interface is connected to the outside of the motor and may have air introduced and discharged therethrough.

The sleeve 112 may support the shaft 111 so that an upper end of the shaft 111 is protruded in an upward axial direction. The sleeve 112 may be formed by sintering a Cu—Fe-based alloy powder or an SUS-based powder. However, the sleeve is not limited to being manufactured by the above-mentioned method, but may be manufactured by various methods.

In this configuration, the shaft 111 may be inserted into a shaft hole of the sleeve 112 to have a micro clearance therewith to thereby serve as a bearing clearance C. The bearing clearance C may be filled with oil, and rotation of the rotor 120 may be smoothly supported by upper and lower radial dynamic pressure grooves 114 formed in at least one of an outer circumferential surface of the shaft 111 and an inner circumferential surface of the sleeve 112.

The radial dynamic pressure grooves 114 may be formed in an inner surface of the sleeve 112, which is an inner portion of the shaft hole of the sleeve 112, and generate pressure so that the shaft 111 may rotate smoothly in a state in which the shaft 111 is separated from the sleeve 112 by a predetermined interval at the time of rotation thereof.

However, the radial dynamic pressure groove 114 is not limited to being formed in the inner surface of the sleeve 112 as described above but may also be formed in an outer circumferential surface portion of the shaft 111. In addition, the number of radial dynamic pressure grooves 114 is not limited.

The radial dynamic pressure groove 114 may have at least one of a herringbone shape, a spiral shape, and a helix shape. However, the radial dynamic pressure groove 114 may have any shape as long as radial dynamic pressure may be generated thereby.

The sleeve 112 may include a circulation hole 117 formed therein so as to communicate between upper and lower portions thereof to disperse pressure of the oil in an inner portion of the hydrodynamic bearing assembly 110, thereby maintaining balance of the pressure, and may move air bubbles, or the like, present in the inner portion of the hydrodynamic bearing assembly 110, to be discharged by circulation.

Here, a lower end of the sleeve 112 may be provided with the stopper 111a protruded from a lower end portion of the shaft 111 in the outer diameter direction. This stopper 111a may be caught by a lower end surface of the sleeve 112 to limit floating of the shaft 111 and the rotor 120.

The spindle motor according to the embodiment of the present invention may use a fluid bearing. Generally, the spindle motor may include a pair of upper and lower radial dynamic pressure grooves 114 for rotation stability to allow two fluid bearings to be formed. However, in the case of the motor using the hydrodynamic bearing, since the rotating member needs to rotate in a state in which it is floated at a predetermined height to thus not contact a bottom plate (a cover member 113 in the present embodiment), the fluid may be continuously pumped in a downward axial direction.

Meanwhile, a groove shaped reservoir part 115 may be formed in at least one of the sleeve 112 and the shaft 111 between the upper and lower radial dynamic grooves 114 so that the bearing clearance between the sleeve 112 and the shaft 111 is wider than that of other portions. Although FIG. 1 shows that the reservoir part 115 is formed in an inner peripheral surface of the sleeve 112 in a circumferential direction, the present invention is not limited thereto. That is, the reservoir part 115 may be formed in the outer peripheral surface of the shaft 111 in the circumferential direction.

Meanwhile, the sleeve 112 may include a cover member 113 coupled thereto at a lower portion thereof in the axial direction, having a clearance therebetween, wherein the clearance receives the oil therein.

The cover member 113 may receive the oil in the clearance between the cover member 113 and the sleeve 112 to thereby serve as a bearing supporting a lower surface of the shaft 111.

The hub 121, a rotating member coupled to the shaft 111 and rotating together therewith, may configure the rotor 120 simultaneously with configuring the hydrodynamic bearing assembly 110. Hereinafter, the rotor 120 will be described in detail.

The rotor 120 is a rotating structure provided to be rotatable with respect to the stator 130 and may include the hub 121 having an annular ring-shaped magnet 125 provided on an outer peripheral surface thereof, wherein the annular ring-shaped magnet 125 corresponds to a core 131 to be described below, having a predetermined interval therebetween.

In other words, the hub 121 may be a rotating member coupled to the shaft 111 to thereby rotate together therewith.

Here, as the magnet 125, a permanent magnet generating magnetic force having predetermined strength by alternately magnetizing an N pole and an S pole thereof in a circumferential direction may be used.

In addition, the hub 121 may include a first cylindrical wall part 122 fixed to an upper end of the shaft 111, a disk part 123 extended from an end portion of the first cylindrical wall part 122 in the outer diameter direction, and a second cylindrical wall part 124 protruded downwardly from an end portion of the disk part 123 in the outer diameter direction, wherein the second cylindrical wall part 124 may include the magnet 125 coupled to an inner peripheral surface thereof.

The hub 121 may have a main wall part 126 extended in the downward axial direction so as to correspond to an outer portion of the upper portion of the sleeve 112. More specifically, the hub 121 may include the main wall part 126 extended from the disk part 123 in the downward axial direction. A liquid-vapor interface sealing the oil may be formed between the outer potion of the sleeve 112 and an inner portion of the main wall part 126.

In addition, an inner surface of the main wall part 126 may be tapered, such that an interval between the inner surface of the main wall part 126 and an outer surface of the sleeve 112 widens in the downward axial direction to thereby facilitate the sealing of the oil. Further, the outer surface of the sleeve 112 may also be tapered to thereby facilitate the sealing of the oil.

In addition, the outer surface of the main wall part 126 may be formed to correspond to an inner surface 135 of at least a portion of a mounting part 134 protruded upwardly from the base member 133 and may be stepped or tapered so that an interval between the main wall part 126 and the mounting part 134 widens in the downward axial direction. A detailed description thereof will be provided after a description of a stator 130.

The stator 130 may include a coil 132, a core 131, and a base member 133.

In other words, the stator 130 may be a fixed structure that includes the coil 132 generating electromagnetic force having a predetermined magnitude at the time of an application of power and a plurality of cores 131 having the coil 132 wound therearound.

The core 131 may be fixedly disposed on an upper portion of the base member 133 including a printed circuit board (not shown) having pattern circuits printed thereon, the upper surface of the base member 133 corresponding to the winding coil 132 may be formed to have a plurality of coil holes having a predetermined size and penetrating through the base member 133 so as to expose the winding coil 132 downwardly, and the winding coil 132 may be electrically connected to the printed circuit board (not shown) so that external power may be supplied thereto.

The outer peripheral surface of the sleeve 112 may be fixed to the base member 133 and the core 131 having the coil 132 wound therearound may be inserted into the base member 133. In addition, the base member 133 and the sleeve 112 may be coupled to each other by applying an adhesive to an inner surface of the base member 133 or an outer surface of the sleeve 112.

In addition, the base member 133 may include the mounting part 134 protruded in the upward axial direction. Therefore, the core 131 may be mounted on an outer surface of the base member 133, the above-mentioned sleeve 112 may be fitted into and fixed to a portion of the inner surface thereof, and the outer surface of the main wall part 126 may be formed to correspond to another portion 135 of the inner surface thereof.

According to an embodiment of the present invention, an interval between the main wall part 126 and the mounting part 134 may widen in the downward axial direction. To this end, a surface of the main wall part 126 and the mounting part 134 facing each other may be tapered or stepped, which will be divided into respective embodiments and will be described hereinafter.

First, referring to FIG. 1, a spindle motor according to another embodiment of the present invention is disclosed. A spindle motor capable of efficiently preventing fluid leakage through a simple structural change according to the embodiment of the present invention is provided.

More specifically, the embodiment of the present invention provides a spindle motor capable of preventing oil from being separated from a liquid-vapor interface by having a structure allowing air to flow from an outer side of a portion at which the liquid-vapor interface is formed, that is, an air side, toward the liquid-vapor interface.

Therefore, in the embodiment of the present invention, the inner surface of the mounting part 134 or 135 may be formed to have at least one step 139 so as to be protruded in the inner diameter direction in the downward axial direction, the outer surface of the main wall part 126 may be stepped in the inner diameter direction so as to correspond to the step formed at the inner surface of the mounting part 134 or 135, and in corresponding surfaces where the inner surface of the mounting part 134 or 135 and the outer surface of the main wall part 126 face each other, an interval between the respective corresponding surfaces distinguished from each other by the steps 129 and 139 may widen in the downward axial direction. Here, the interval between the corresponding surfaces may refer to a distance in a radial direction.

That is, in FIG. 1, the outer surface of the main wall part 126 may be divided into a first outer surface 127 and a second outer surface 128, based on the step 129, and the inner surface of the mounting part 134 or 135 may be divided into a first inner surface 137 and a second inner surface 138 based on the step 139. Although FIG. 1 shows the case in which only one step 129 or 139 is provided, two or more steps may be provided, and each of the number of outer surfaces of the main wall part 126 and the number of inner surfaces of the mounting part 134 or 135 may be greater than the number of steps by one.

Here, an interval G1 between the corresponding surfaces where the first outer surface 127 and the first inner surface 137 face each other may be smaller than an interval G2 between the corresponding surfaces where the second outer surface 128 and the second inner surface 138 face each other.

Further, the interval G1 between the corresponding surfaces where the first outer surface 127 and the first inner surface 137 face each other may have a labyrinth seal formed therebetween. That is, the corresponding surfaces at which a narrowest point in the interval between the outer surface of the main wall part 126 and the inner surface of the mounting part 134 or 135 is provided may have a labyrinth seal formed therein.

Meanwhile, the outer surface of the main surface 126 may be divided into the first outer surface 127 and the second outer surface 128, based on the step 129. When it is assumed that a rotating radius from a rotational axis R of the spindle motor to the first outer surface 127 is a first rotational radius R1 and a rotational radius from the rotational axis R of the spindle motor to the second outer surface 128 is a second rotational radius R2, R1 may be larger than R2.

According to the embodiment of the present invention, air may be introduced and discharged through a communications path between an oil interface and the outside, such that there may be a difference in generated pressure according to a size or a position of the communications path. That is, when a diameter (a width of across section) of the communications path increases, the pressure of a fluid (air) may decrease, and when the diameter (the width of the cross section) decreases, the pressure of the fluid (air) may be increased. In addition, since a fluid (air) adjacent to a member having a larger rotational radius based on the rotational axis R has a linear velocity larger than that of a fluid (air) adjacent to a member having a smaller rotational radius based on the rotational axis R, it may have pressure greater than that of the fluid (air) adjacent to the member having the smaller rotational radius based on the rotational axis R.

The above-mentioned principle may be used according to the embodiment of the present invention. As shown in FIG. 1, a first interval G1, which is an interval between the corresponding surfaces positioned more distant from the liquid-vapor interface where the oil is sealed along the communications path, may be smaller than a second interval G2, which is an interval between the corresponding surfaces positioned closer to the liquid-vapor interface, to allow the pressure of the fluid (air) to be larger in a portion at which the first interval G1 is formed than in a portion at which the second interval G2 is formed, thereby automatically generating force pumping the fluid (air) toward the oil interface (in an arrow direction).

Further, the first rotational radius R1 of the first outer surface 127 forming the first interval G1 which is the interval between the corresponding surfaces positioned more distant from the liquid-vapor interface where the oil is sealed along the communications path, may be larger than the second rotational radius R2 of the second outer surface 128 forming the second interval G2 which is the interval between the corresponding surfaces positioned closer to the liquid-vapor interface, to allow the pressure of the fluid (air) to be larger at the portion at which the first interval G1 is formed than at the portion at which the second interval G2 is formed, thereby automatically generating the force pumping the fluid (air) toward the oil interface (in the arrow direction.

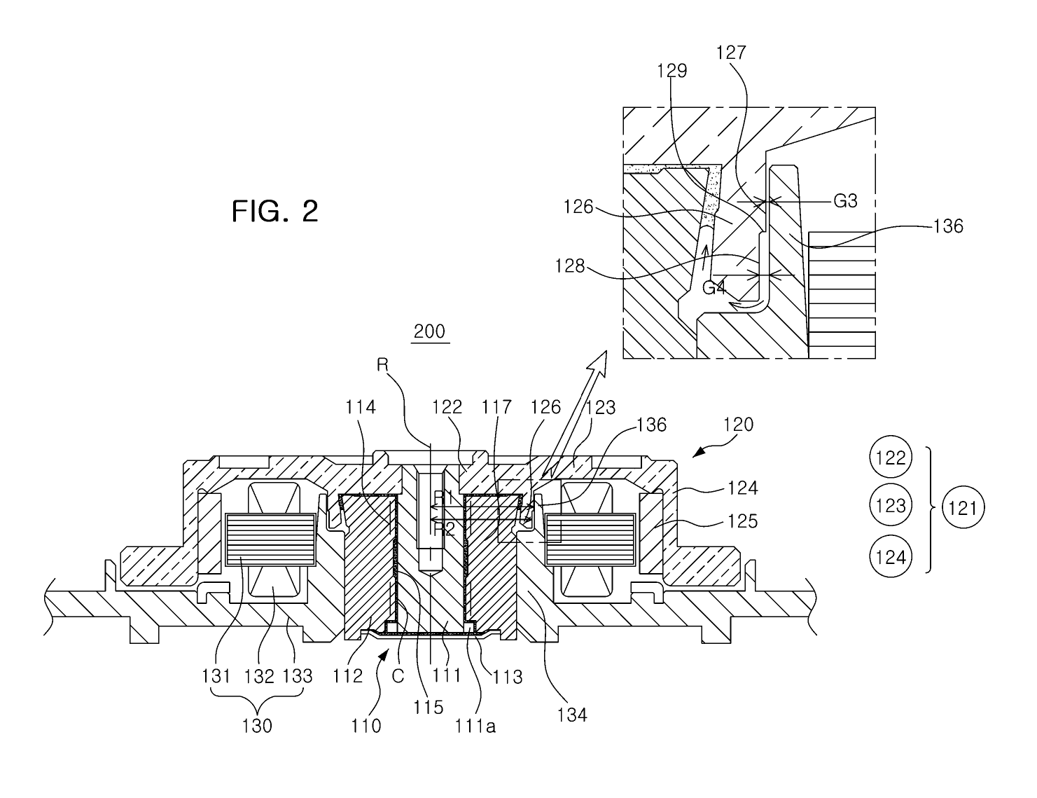

FIG. 2 is a schematic cross-sectional view showing a spindle motor according to another embodiment of the present invention.

Referring to FIG. 2, the spindle motor according to the embodiment of the present invention has the same configuration as that the spindle motor according to the embodiment of the present invention except for structures of an outer surface of a main wall part 126 and an inner surface of a mounting part 134. Therefore, hereinafter, only a configuration different from that of the spindle motor according to the embodiment of the present invention will be described in detail, and a description of the same configuration as that of the spindle motor according to the embodiment of the present invention will be omitted.

The outer surface of the main wall part 126 may be formed to correspond to the inner surface 136 of at least a portion of the mounting part 134 protruded upwardly from the base member 133 and may be stepped so that an interval between the main wall part 126 and the mounting part 134 widens in the downward axial direction.

That is, as shown in FIG. 2, the inner surface of the mounting part 134 or 136 may be formed as a surface extended linearly in the axial direction, rather than being stepped or tapered, and the outer surface of the main wall part 126 may be stepped so that an interval between the main wall part 126 and the mounting part 134 widens in the downward axial direction.

That is, in FIG. 2, the outer surface of the main wall part 126 may be divided into a first outer surface 127 and a second outer surface 128 based on the step 129. Although FIG. 2 shows a case in which only one step 129 is provided, two or more steps may be provided, and the number of outer surfaces of the main wall part 126 may be larger than the number of steps by one.

Here, an interval G3 between corresponding surfaces where the first outer surface 127 and the inner surface of the mounting part 134 or 136 face each other may be smaller than an interval G4 between corresponding surfaces where the second outer surface 128 and the inner surface of the mounting part 134 or 136 face each other.

Further, the interval G3 between the corresponding surfaces where the first outer surface 127 and the inner surface of the mounting part 134 or 136 face each other may have a labyrinth seal formed therein. That is, the corresponding surfaces at which a narrowest point in the interval between the outer surface of the main wall part 126 and the inner surface of the mounting part 134 or 136 is provided may have a labyrinth seal formed therein.

Meanwhile, the outer surface of the main surface 126 may be divided into the first outer surface 127 and the second outer surface 128 based on the step 129. When it is assumed that a rotating radius from a rotational axis R of the spindle motor to the first outer surface 127 is a first rotational radius R1 and a rotational radius from the rotational axis R of the spindle motor to the second outer surface 128 is a second rotational radius R2, R1 may be larger than R2.

According to the embodiment of the present invention, air may be introduced and discharged through a communications path between an oil interface and the outside, such that there may be a difference in generated pressure according to a size or a position of the communications path. That is, when a diameter (a width of a cross section) of the communications path increases, pressure of a fluid (air) may decrease, and when the diameter (the width of the cross section) decreases, the pressure of the fluid (air) may be increased. In addition, since a fluid (air) adjacent to a member having a larger rotational radius based on the rotational axis R has linear velocity larger than that of a fluid (air) adjacent to a member having a smaller rotational radius based on the rotational axis R, it may have pressure greater than that of the fluid (air) adjacent to the member having the smaller rotational radius based on the rotational axis R.

The embodiment of the present invention uses the above-mentioned principle. As shown in FIG. 2, a third interval G3, which is an interval between the corresponding surfaces positioned more distant from the liquid-vapor interface on which the oil is sealed along the communications path, may be smaller than a fourth interval G4, which is an interval between the corresponding surfaces positioned closer to the liquid-vapor interface, to allow the pressure of the fluid (air) to be larger in a portion at which the third interval G3 is formed than in a portion at which the fourth interval G4 is formed, thereby automatically generating force pumping the fluid (air) toward the oil interface (in an arrow direction).

Further, the first rotational radius R1 of the first outer surface 127 forming the third interval G3, which is the interval between the corresponding surfaces positioned more distant from the liquid-vapor interface on which the oil is sealed along the communications path, may be larger than the second rotational radius R2 of the second outer surface 128 forming the fourth interval G4, which is the interval between the corresponding surfaces positioned closer to the liquid-vapor interface, to allow the pressure of the fluid (air) to be larger in the portion at which the third interval G3 is formed than in the portion at which the fourth interval G4 is formed, thereby automatically generating the force pumping the fluid (air) toward the oil interface (in the arrow direction.

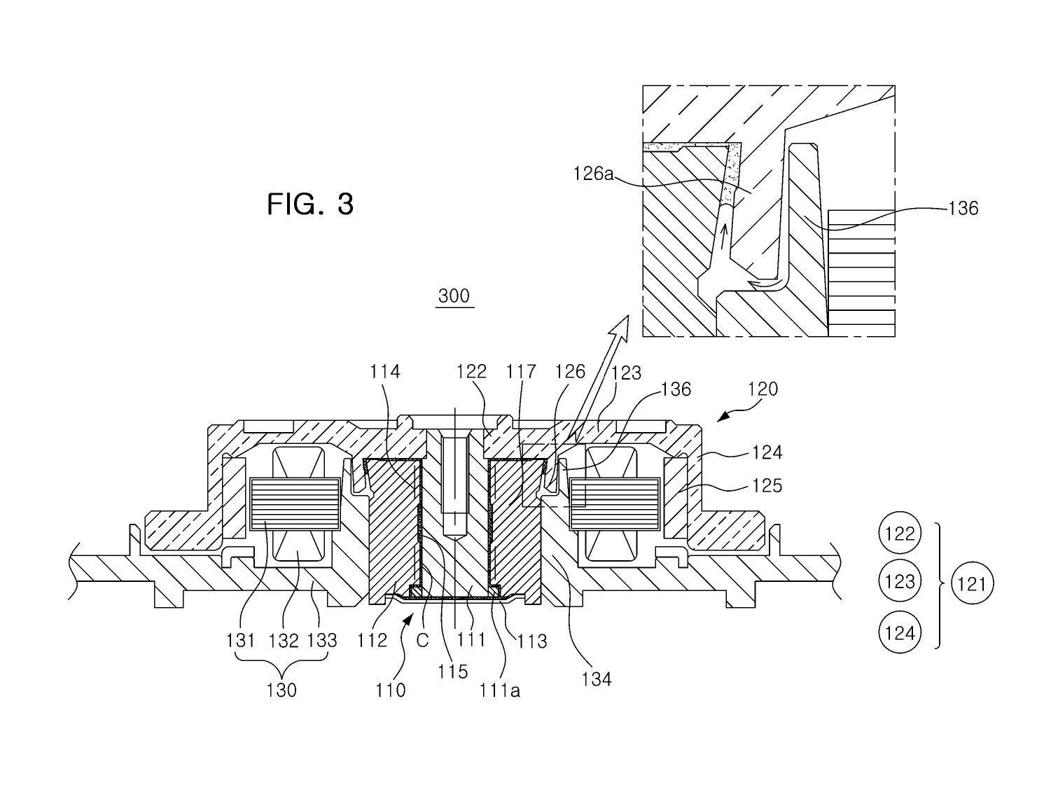

FIG. 3 is a schematic cross-sectional view showing a spindle motor according to another embodiment of the present invention.

Referring to FIG. 3, the spindle motor according to the embodiment of the present invention has the same configuration as that the spindle motor according to the embodiment of the present invention except for structures of an outer surface of a main wall part 126 and an inner surface of a mounting part 134. Therefore, hereinafter, only configurations different from that of the spindle motor according to the embodiment of the present invention will be described in detail, and a description of configurations the same as that of the spindle motor according to the embodiment of the present invention will be omitted.

The outer surface of the main wall part 126 may be formed to correspond to the inner surface 136 of at least a portion of the mounting part 134 protruded upwardly from the base member 133 and may be tapered so that an interval between the main wall part 126 and the mounting part 134 widens in the downward axial direction.

That is, as shown in FIG. 3, the inner surface of the mounting part 134 or 136 may be formed as a surface extended linearly in the axial direction rather than being stepped or tapered, and the outer surface of the main wall part 126 may be tapered so that an interval between the main wall part 126 and the mounting part 134 widens in the downward axial direction.

In FIG. 3, at least a portion of the outer surface of the main wall part 126 may be tapered in the inner diameter direction in the downward axial direction. Although FIG. 3 shows the case in which a relatively large portion of the outer surface of the main wall part 126 is tapered, this is an example. That is, only a portion of the main wall part may be tapered.

Here, an interval between the corresponding surfaces where the outer surface of the main surface 126 and the inner surface of the mounting part 134 or 136 face each other may be smaller in an upper portion in the axial direction than in a lower portion in the axial direction.

Further, an interval between the outer surface of the main surface 126 and the inner surface of the mounting part 134 or 136 at an uppermost portion in which the main wall part 126 starts to be tapered in the corresponding surfaces where the outer surface of the main surface 126 and the inner surface of the mounting part 134 or 136 face each other may be small enough to have a labyrinth seal formed therein. That is, the corresponding surfaces at which a narrowest point in the interval between the outer surface of the main wall part 126 and the inner surface of the mounting part 134 or 136 is provided may have a labyrinth seal formed therein.

Meanwhile, a rotational radius from the rotational axis R of the spindle motor to the outer surface of the main wall part 126 may also become larger in the downward axial direction.

According to the embodiment of the present invention, air may be introduced and discharged through a communications path between an oil interface and the outside, such that there may be a difference in generated pressure according to a size or a position of the communications path. That is, when a diameter (a width of across section) of the communications path increases, pressure of a fluid (air) may decrease, and when the diameter (the width of the cross section) decreases, the pressure of the fluid (air) may be increased. In addition, since a fluid (air) adjacent to a member having a larger rotational radius based on the rotational axis R has linear velocity larger than that of a fluid (air) adjacent to a member having a smaller rotational radius based on the rotational axis R, it may have pressure greater than that of the fluid (air) adjacent to the member having the smaller rotational radius based on the rotational axis R.

The embodiment of the present invention uses the above-mentioned principle. As shown in FIG. 3, an interval between the corresponding surfaces positioned more distant from the liquid-vapor interface where the oil is sealed along the communications path, may be smaller than an interval between the corresponding surfaces positioned closer to the liquid-vapor interface, to allow the pressure of the fluid (air) to be larger between the corresponding surfaces positioned more distant from the liquid-vapor interface along the communications path than between the corresponding surfaces positioned closer to the liquid-vapor interface, thereby automatically generating force pumping the fluid (air) toward the oil interface (in an arrow direction).

Further, the rotational radius of the outer surface of the main wall part 126 forming the interval between the corresponding surfaces positioned more distant from the liquid-vapor interface where the oil is sealed along the communications path, may be larger than that of the outer surface of the main wall part 126 forming the interval between the corresponding surfaces positioned closer to the liquid-vapor interface, to allow the pressure of the fluid (air) to be larger between the corresponding surfaces positioned more distant from the liquid-vapor interface along the communications path than between the corresponding surfaces positioned closer to the liquid-vapor interface, thereby automatically generating force pumping the fluid (air) toward the oil interface (in an arrow direction).

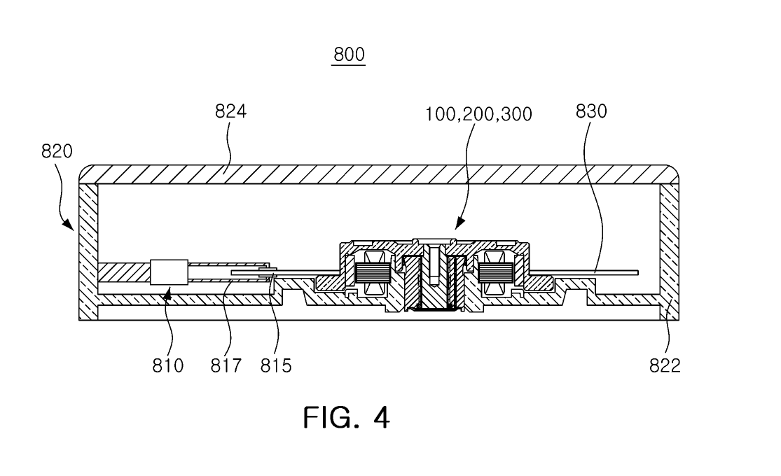

Referring to FIG. 4, a recording disk driving device 800 having the spindle motor 100, 200, or 300 according to the embodiment of the present invention mounted therein is a hard disk driving device and may include the spindle motor 100, 200 or 300, a head transfer part 810, and a housing 820.

The spindle motor 100, 200 or 300 has all the characteristics of the motor according to the embodiments of the present invention described above and may have a recording disk 830 mounted thereon.

The head transfer part 810 may transfer a head 815 detecting information of the recording disk 830 mounted on the spindle motor 100, 200, or 300 to a surface of the recording disk of which the information is to be detected.

Here, the head 815 may be disposed on a support part 817 of the head transfer part 810.

The housing 820 may include a motor mounting plate 822 and a top cover 824 shielding an upper portion of the motor mounting plate 822 in order to form an internal space receiving the spindle motor 100, 200, or 300 and the head transfer part 810 therein.

As set forth above, according to the embodiments of the present invention, the spindle motor capable of efficiently preventing leakage of the fluid through a simple structural change may be provided.

More specifically, the spindle motor capable of preventing oil from being separated from the liquid-vapor interface by having a structure allowing air to flow from an outer side of a portion in which the liquid-vapor interface is formed, that is, from an air side, toward the liquid-vapor interface may be provided.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve provided with a shaft protruded in an upward axial direction and having oil filling a bearing clearance formed between the sleeve and the shaft, the sleeve rotatably supporting the shaft;
a base member including a mounting part protruded in the upward axial direction, the mounting part having the sleeve fixed to an inner surface thereof; and
a hub fixed to an upper portion of the shaft and including a main wall part extended in a downward axial direction, the main wall part being formed with at least a portion of an inner surface thereof corresponding to an outer surface of the sleeve and being formed with at least a portion of an outer surface thereof corresponding to the inner surface of the mounting part,
the main wall part and the mounting part having an interval therebetween widening in the downward axial direction.

2. The spindle motor of claim 1, wherein the outer surface of the main wall part is at least partially tapered so that an interval between the main wall part and the mounting part widens in the downward axial direction.

3. The spindle motor of claim 1, wherein the outer surface of the main wall part is formed to have at least one step so that an interval between the main wall part and the mounting part widens in the downward axial direction.

4. The spindle motor of claim 3, wherein the interval between the main wall part and the mounting part have a labyrinth seal formed therein at a narrowest point thereof.

5. The spindle motor of claim 1, wherein the inner surface of the mounting part is formed to have at least one step so as to be protruded in an inner diameter direction in the downward axial direction.

6. The spindle motor of claim 5, wherein the outer surface of the main wall part is stepped in the inner diameter direction so as to correspond to the step formed at the inner surface of the mounting part, and
the mounting part and the main wall part have respective corresponding surfaces on which the inner surface of the mounting part and the outer surface of the main wall part face each other, an interval between the respective corresponding surfaces distinguished from each other by the step widening in the downward axial direction.

7. The spindle motor of claim 6, wherein the corresponding surfaces at which a narrowest point in the interval between the outer surface of the main wall part and the inner surface of the mounting part is provided form a labyrinth seal.

8. The spindle motor of claim 1, wherein the outer surface of the sleeve and the inner surface of the main wall part have a liquid-vapor interface formed therebetween.

9. A hard disk drive comprising:
the spindle motor of claim 1 rotating a disk with power applied through a board;
a magnetic head writing data to the disk and reading the data from the disk; and
a head driving part moving the magnetic head to a predetermined position on the disk.
